(19) United States
(12) Patent Application Publication
(10) Pub. No.: US 2010/0212993 A1
(43) Pub. Date: Aug. 26, 2010

(54) Belt driven wheel support and suspension system on a personal wheeled vehicle

(76) Inventor: Brian Gagnon, Coral Springs, FL (US)

Correspondence Address: ROBERT M. DOWNEY, P.A., 6751 N. FEDERAL HWY., SUITE 300, BOCA RATON, FL, 33487, US

(21) Appl. No.: 12/799,780

(22) Filed: Apr. 29, 2010

Related U.S. Application Data
(63) Continuation-in-part of application No. 11/731,097, filed on Mar. 29, 2007.

(51) Int. Cl. B60K 17/08

(52) U.S. Cl. 180/357

(57) ABSTRACT

A belt drive and wheel support and suspension system for a personal wheeled vehicle has a drive pulley for fixed attachment to a rotating power source and a driven pulley for fixed attachment to a wheel of the vehicle. Each of the drive pulley and the driven pulley have a belt engagement face including a plurality of cogs arranged at an oblique angle on the belt engagement faces. An endless belt extends between the drive pulley and the driven pulley and has a plurality of cogs affixed to an inner face of the endless belt that are arranged at a like oblique angle with respect to the cogs on the drive and driven pulleys for positive intermeshing engagement with the cogs on the pulleys. A suspension arm is coaxially supported with the drive pulley and is pivotally moveable about a rotation axis of the rotating power source. An opposite end of the suspension arm is connected to the vehicle by a shock absorbing member and rotatably supports the wheel and driven pulley to thereby allow upward and downward movement of the wheel and driven pulley while maintaining the belt in positive engagement with the drive and driven pulleys.

This is a Continuation-In-Part patent application of co-pending patent application Ser. No. 11/731,097 filed on Mar. 29, 2007.

### BACKGROUND OF THE INVENTION

1. Field of the Invention

The present invention relates to drive and suspension systems and more particularly to a belt and pulley drive arrangement on a suspension arm for supporting and driving one or more wheels of a personal wheeled vehicle.

2. Discussion of the Related Art

Personal wheeled vehicles have long been in use in society for assisting individuals from traveling from one place to another. One of the most common personal wheeled vehicles is a wheel chair. Wheel chairs were initially designed with hard narrow wheels for the ease of propelling them across the hard surfaces. For many years, wheel chairs were limited in their use for the person seated in the wheel chair to be pushed by another person over a hard surface or for large side wheels to be grasped by the user to self-propel the wheel chair across the hard surface.

Individuals using these vehicles, typically required to do so because of a physical impairment, are now seeking increased mobility to places and terrain not traditionally accessed by these vehicles. Thus, in recent years, such personal wheeled vehicles have incorporated various design modifications and taken various new forms such as applicant's wheelchair which is the subject of Utility Pat. 6,073,958 and Design Pat. 401,191 which are hereby incorporated by reference. New compact electric powered vehicles have been developed to give people improved mobility. Wheelchairs have been specially designed for racing and for various sports. Additionally, wheelchairs have been fitted with batteries and electric motors for powered travel.

In recent years people have trended to cross-country activities. Mountain biking has become extremely popular in recent years. Consequently, wheelchairs have been designed to provide all-terrain-like capabilities with improved stability and wider wheels to permit traversing across soft ground. Ideally, all-terrain wheel chairs can be fitted with batteries and electric motors to permit individuals to enjoy the pleasures of all terrain travel without having to physically exert themselves. However, the drive mechanisms, such as belt and pulley systems, of these vehicles have typically been susceptible to a variety of malfunctions, including excess belt slippage and disengagement of the drive belt from one or more of the pulleys.

Thus, what is desired is a belt and pulley system supported on a wheel suspension member for a personal motor powered vehicle and wherein the belt driven system that resists slippage and misalignment.

### SUMMARY OF THE INVENTION

One aspect of the present invention is a belt driven wheel support and suspension system for a personal wheeled vehicle. The system has a drive pulley for fixed attachment to a rotating power source and a driven pulley for fixed attachment to a wheel of the vehicle. Each of the drive pulley and the driven pulley have a belt engagement face including a plurality of cogs arranged at an oblique angle on the belt engagement faces. An endless belt extends between the drive pulley and the driven pulley and has a plurality of cogs affixed to an inner face of the endless belt that are arranged at a like oblique angle with respect to the cogs on the drive and driven pulleys for positive intermeshing engagement with the cogs on the pulleys. A suspension arm is co-axially mounted with the drive pulley and is pivotally moveable about the axis of the drive pulley. The wheel axle is mounted near an opposite end of the suspension arm. A shock absorbing device attaches between the opposite end of the suspension arm and the frame of the vehicle, thereby allowing the wheel and the driven pulley to move up and down while absorbing bumps on uneven terrain while maintaining positive engagement of the belt with the drive pulley and driven pulley.

Another aspect of the present invention is a belt drive and wheel suspension system for a personal wheeled vehicle including a drive pulley for fixed attachment to a rotating power source and a driven pulley for fixed attachment to a wheel supported on a spring biased suspension arm of the vehicle. Each of the pulleys includes a belt engagement face about a periphery thereof. An endless belt having an inner face extends between the drive pulley and the driven pulley such that the drive pulley and the driven pulley in combination with the endless belt and suspension arm define a positive engagement self-centering interface.

Yet another aspect of the present invention is a belt drive and wheel suspension system for a personal wheeled vehicle including drive and driven pulleys each having a belt engagement face and an endless belt extending between the pulleys. The pulleys in combination with the endless belt and a suspension arm define a positive engagement self-centering interface having a plurality of cogs arranged in a herringbone pattern and centered about a longitudinal centerline of the endless belt. A belt tensioner including an adjustable pulley bears on an outer surface of said endless belt.

These and other advantages of the invention will be further understood and appreciated by those skilled in the art by reference to the following written specification, claims and appended drawings.

### BRIEF DESCRIPTION OF THE DRAWINGS

For a fuller understanding of the nature of the present invention, reference should be made to the following detailed description taken in conjunction with the accompanying drawings in which:

FIG. 1 is a rear elevation view of an electrically powered wheel chair embodying the present invention;

FIG. 2 is a cross-sectional view of the wheel chair shown in FIG. 1 and taken along the line 2-2, FIG. 1;

FIG. 3 is an enlarged elevation view of the belt and pulley drive arrangement and the wheel support and suspension system shown in FIG. 2 and encompassed by the designated area 3, FIG. 2.

FIG. 4 is an inside view of the belt illustrating the belt cog pattern and taken along the line 4-4, FIG. 3;

FIG. 5 is an edge view of one of the pulleys illustrating the pulley cog pattern and taken along the line 5-5, FIG. 3;

FIG. 6 is a partial elevation cross-section of the pulley shown in FIG. 5, and taken along the line 6-6.

Like reference numerals refer to like parts throughout the several views of the drawings.

### DETAILED DESCRIPTION OF THE PREFERRED EMBODIMENTS

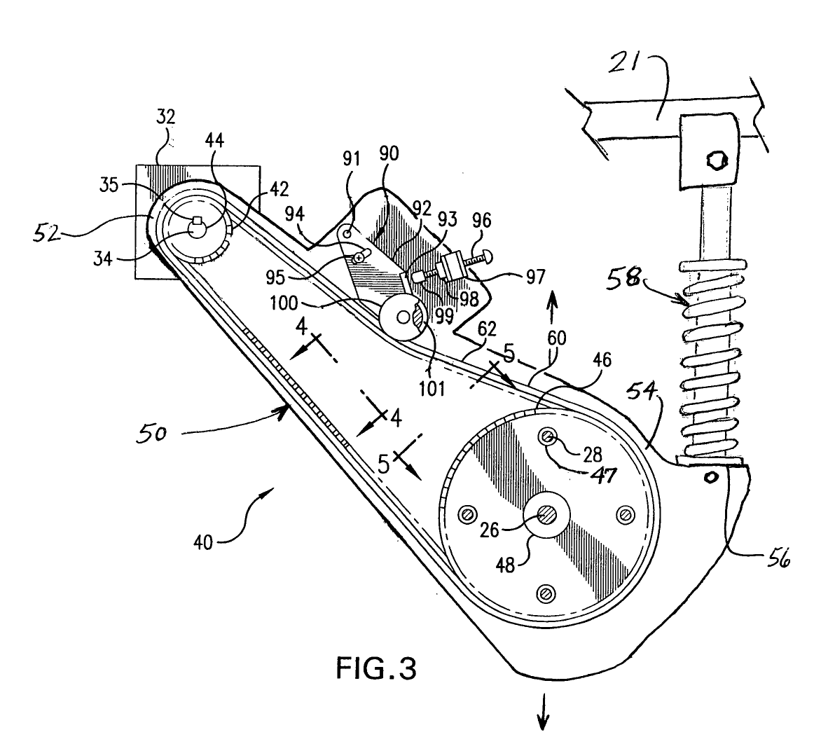

For purposes of description herein, the terms “upper”, “lower”, “left”, “rear”, “right”, “front”, “vertical”, “horizontal”, and derivatives thereof shall relate to the invention as oriented in FIG. 3. However, one will understand that the invention may assume various alternative orientations and step sequences, except where expressly specified to the contrary. While the present invention has been shown and described in accordance with preferred and practical embodiments thereof, it is recognized that departures from the instant disclosure are fully contemplated within the spirit and scope of the invention. Hence, specific dimensions and other physical characteristics relating to the embodiments disclosed herein are not to be considered as limiting, unless the claims expressly state otherwise.

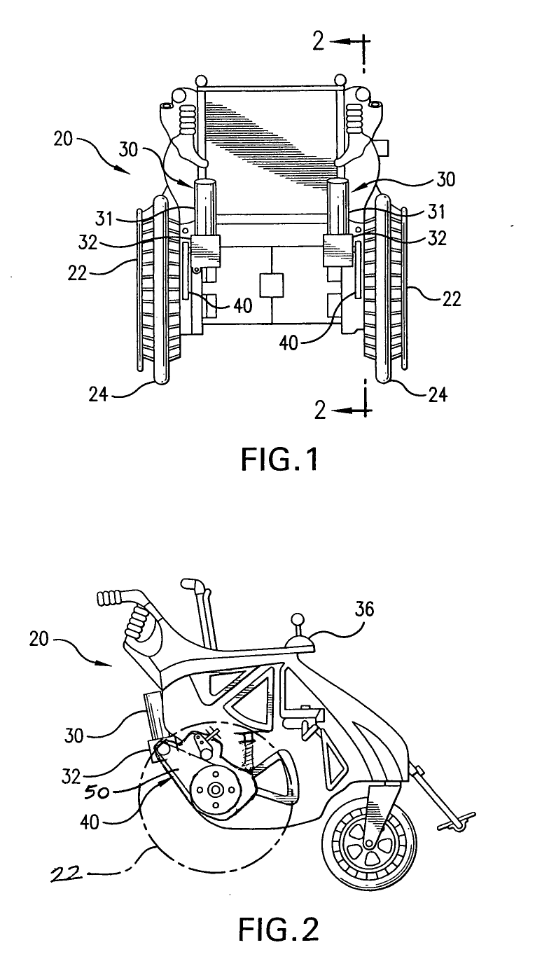

Turning to the drawings, FIGS. 1 and 2 show a wheelchair 20 incorporating a belt and pulley drive system 40 which is one of the preferred embodiments of the present invention and illustrates its various components. Wheelchair 20 is designed for all-terrain use wherein wheels 22 have a larger width than the typical wheelchair to support the wheelchair in soft terrain. Wheels 22 include a standard tire 24 for ease of use on hard surfaces. Electric drive units 30 are mounted on left and right sides of a rear of wheelchair 20. Electric drive units 30 are powered by batteries (not shown) housed in a lower part of wheelchair 20. Electric drive units 30 comprise an electric motor 31 and a reduction gearbox 32 that output power to propel wheelchair 20 via drive shaft 34. Directional control of wheelchair 20 is achieved through hand controller 36 mounted on a portion of wheelchair 20 accessible by the user.

Turning now to FIGS. 3-6, drive pulley 42 has a central aperture 44 which is sleeved over and affixed to drive shaft 34 of gear reduction box 32 with key 35. Keyed shafts such as shaft 34 and key 35 to fixedly retain a pulley thereon are well known in the art. A suspension arm 50 has a first end zone 52 that is coaxially supported with drive pulley 42 on shaft 34 and is pivotally moveable about the central axis of shaft 34 and relative to the shaft 34 and gear box 32. An opposite end zone 54 of the suspension arm 50 has wheel axle 26 mounted thereto and extending outwardly from the suspension arm 50. Driven pulley 46 has a central aperture 48 is received over wheel axle 26. Aperture 48 is sufficiently large to allow driven pulley 46 to freely rotate therearound. Driven pulley 46 also includes a plurality of holes 47 therethrough positioned such that driven pulley 46 can be affixed to wheel 22 using fasteners 28 wherein rotation of driven pulley 46 causes a like rotation of wheel 22. The diameters of pulleys 42 and 46 are selected with a gear ratio to provide a desired range of speeds for the wheelchair 20. A shock absorbing member 58, such as a spring biased shock absorber, connects between a shock mount portion 56 on the second end zone 54 of the suspension arm 50 and a frame structure 21 of the wheelchair 20 to allow upward movement of the second end zone 54 along with wheel 22 and driven pulley 46 in response to external forces, such as bumps and uneven terrain against wheel 22. The shock absorbing member 58 absorbs the external forces while allowing upward movement of the second end zone 54 of suspension arm 50 and urges the suspension arm downwardly to a normal, relaxed position.

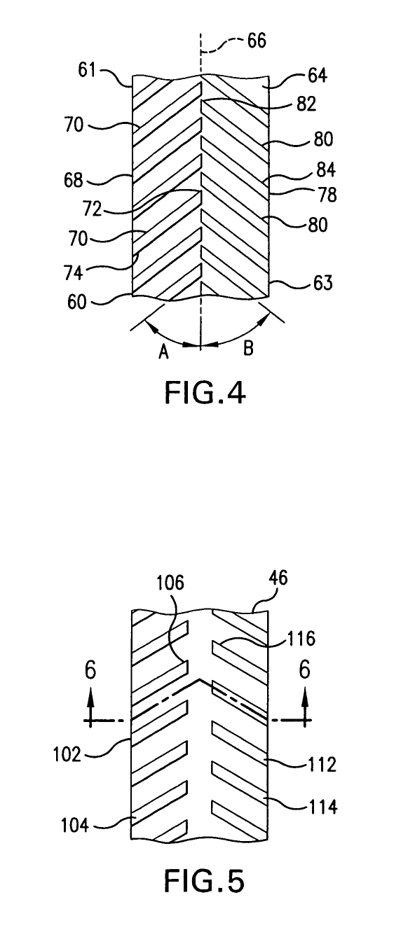

An endless belt 60 extends around and engages the outer peripheries of drive pulley 42 and driven pulley 46. As illustrated n FIG. 4, endless belt 60 has an inner face 64 which has a longitudinal centerline 66. A first group 68 of cogs 70 are affixed to inner face 64 such that inner ends 72 are most proximate to centerline 66 and outer ends 74 are most proximate to an outside edge 61 of endless belt 60. Cogs 70 are arranged substantially in a parallel spaced apart manner along the length of inner face 64 and oriented at an oblique angle “A” with respect to centerline 66. A second group 78 of cogs 80 are affixed to inner face 64 of endless belt 60 laterally opposite from cogs group 68. Inner ends 82 of cogs 80 are most proximate to centerline 66 and outer ends 84 are most proximate to outside edge 63 of endless belt 60. Cogs 80 are also arranged substantially in a parallel spaced apart manner along the length of inner face 64 and oriented at an oblique angle “B” with respect to centerline 66. Oblique angles “A” and “B” while substantially equal, are mirror images one with the other such that adjacent ones of cogs 70 and cogs 80 form a “V” configuration. Cog group 68 can be longitudinally offset from cog group 78 such that an inner end 72 of a cog 70 of cog group 68 is longitudinally aligned between inner ends 82 of the two most proximate cogs 80 of cog group 78 thus forming a herringbone pattern of cogs 70, 80 along inner face 64 of endless belt 60.

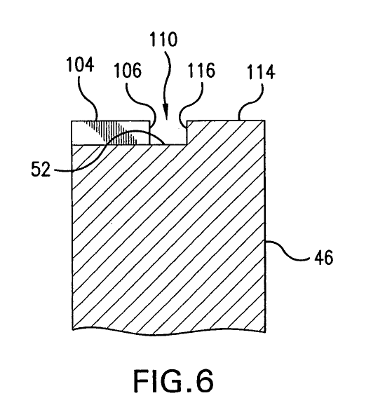

As illustrated in FIGS. 5 and 6, driven pulley 46 (drive pulley 42 being similarly configured) has a belt engagement face 64 on which are positioned a plurality of cogs 104, 114. As with endless belt 60, cogs 104, 114 form two cog groups 102, 112 wherein cogs 104 of cog group 102 are arranged at a first oblique angle and cogs 114 of cog group 112 are arranged at a second mirror image oblique angle. These oblique angles correspond to oblique angles “A” and “B” for endless belt 60 to facilitate intermeshing thereof. Inner ends 106 of cogs 104 and inner ends of cogs 116 of cogs 114 are laterally separated one from the other such that inner ends 106 and 116 in combination with belt engagement face 52 defines a central channel 110 that extends about the periphery of driven pulley 46. Channel 110 aids in the initial engagement of inner ends 72 and 82 of cogs 70 and 80 on endless belt 60 thereby self-centering endless belt 60 on pulleys 42, 46.

Referring again to FIG. 3, the proper operation of endless belt 60 between pulleys 42 and 46 requires endless belt 60 be at a proper tension. In order to maintain a desired tension in endless belt 60, an adjustable belt tensioner 90 is employed, here shown affixed to the suspension arm 50 and moveable with the suspension arm 50, the driven pulley 46 and wheel 22 all relative to drive pulley 42. Tensioner 90 comprises an adjustable arm 92 which is rotatable affixed at one end to side panel 21 of wheelchair 20 with a screw 91. A tension pulley 100 is rotatably affixed to an opposite end of arm 92. Tension pulley 100 has a central recess 101 which receives outside surface 62 of endless belt 60 therein. Arm 92 also defines an adjustment slot 94 which receives screw 95 therethrough for securing arm 92 and has a bearing surface 93. An adjustment screw 96 is threadingly engaged in bracket 97 with an end 99 bearing against bearing surface 93 of arm 92. The tension of endless belt 60 can be adjusted by advancing screw 96 in bracket 97 thereby rotating arm 92 about screw 91 until the bearing force of pulley 100 against endless belt 60 induces the proper tension in endless belt 60. Lock nut 98 can be tightened to fix adjustment screw 96 in a desired position and screws 91 and 95 can be tightened to fix arm 92 to the suspension arm 50.

In the foregoing description those skilled in the art will readily appreciate that while the above application has been directed to a wheelchair, the belt and pulley system can be applied to other personal wheeled vehicles and that modifications may be made to the invention without departing from the concepts disclosed herein. Such modifications are to be considered as included in the following claims, unless these claims expressly state otherwise.

What is claimed is:

1. A belt and pulley drive system for a personal wheeled vehicle having a frame structure, said belt and pulley drive system comprising:
a rotatable wheel on the vehicle for propelling the vehicle over terrain, and said wheel including a tire for engaging the terrain;
a rotating power source including an electric motor and a reduction gearbox having an output drive shaft;
a drive pulley for fixed attachment to said output drive shaft of said gearbox of said rotating power source, said drive pulley having a belt engagement face and a plurality of cogs arranged at an oblique angle on said belt engagement face;
a driven pulley for fixed attachment to said wheel of the vehicle, said driven pulley having a belt engagement face and a plurality of cogs arranged at an oblique angle on said belt engagement face;
an endless belt extending between said drive pulley and said driven pulley and having a plurality of cogs affixed to an inner face of said endless belt, said cogs arranged at a like oblique angle with respect to said cogs on said drive pulley and said driven pulley for positive intermeshing engagement with said cogs on said drive pulley and said driven pulley;
a suspension arm for allowing upward and downward movement of said wheel and said driven pulley relative to said drive pulley and said rotating power source while maintaining said endless belt in said positive intermeshing engagement with said cogs on said drive pulley and said driven pulley, and said suspension arm including a first end zone coaxially mounted with said drive pulley on said output drive shaft and pivotally moveable about a rotational axis of said output drive shaft, and said suspension arm further including an opposite second end zone with a wheel axle fixed thereto and extending therefrom for rotatably supporting said wheel and said driven pulley; and
a shock absorbing member connecting between said second end zone of said suspension arm and the frame structure of the personal wheeled vehicle for allowing upward movement of said wheel and said driven pulley in response to external forces and for urging said wheel downwardly to a normal position.

2. The belt and pulley drive system according to claim 1 wherein said plurality of cogs comprise a first group of cogs and a second group of cogs, said first group of cogs arranged at a first oblique angle and said second group of cogs arranged at a second oblique angle.

3. The belt and pulley drive system according to claim 2 wherein a longitudinal centerline divides said inner face of said endless belt into a first side and a second side and further wherein said first group of cogs are arranged on said first side and said second group of cogs are arranged on said second side.

4. The belt and pulley drive system according to claim 3 wherein said first oblique angle of said first group of cogs and said second oblique angle of said second group of cogs are mirror images one with respect to the other and with respect to said longitudinal centerline of said endless belt.

5. The belt and pulley drive system according to claim 4 wherein said first group of cogs are parallel one with the other and wherein said second group of cogs are parallel one with the other.

6. The belt and pulley drive system according to claim 5 wherein said cogs have inner ends and outer ends and further wherein said first group of cogs is longitudinally offset from said second group of cogs such that an inner ed of a cog from said first group is longitudinally aligned between said inner ends of two most adjacent cogs of said second group of cogs.

7. The belt and pulley drive system according to claim 6 wherein said first group of cogs and said second group of cogs are arranged in a herringbone pattern with respect to said longitudinal center line of said inner surface of said endless belt.

8. The belt and pulley drive system according to claim 7 wherein said cogs on said drive pulley and on said driven pulley are arranged in a like herringbone pattern.

9. The belt and pulley drive system according to claim 8 wherein said inner ends of said first group of cogs on said drive pulley and on said driven pulley are laterally separated from said inner ends of said second group of cogs.

10. The belt and pulley drive system according to claim 1 further including a belt tensioner.

11. The belt and pulley drive system according to claim 10 wherein said belt tensioner is an adjustable pulley.

12. The belt and pulley drive system according to claim 11 wherein said adjustable pulley bears against an outside surface of said endless belt.

13. A belt and pulley drive system for a personal wheeled vehicle having a frame structure, said belt and pulley drive system comprising:
a rotatable wheel on the vehicle for propelling the vehicle over terrain, and said wheel including a tire for engaging the terrain;
a rotating power source including an electric motor and a reduction gearbox having an output drive shaft;
a drive pulley for fixed attachment to said output drive shaft of said gearbox of said rotating power source, said drive pulley having a belt engagement face;
a driven pulley for fixed attachment to said wheel of the vehicle, said driven pulley having a belt engagement face;
an endless belt having an inner face and extending between said drive pulley and said driven pulley wherein said drive pulley and said driven pulley in combination with said endless belt have a positive engagement self-centering interface;
a suspension arm for allowing upward and downward movement of said wheel and said driven pulley relative to said drive pulley and said rotating power source while maintaining said endless belt in positive intermeshing engagement with said cogs on said drive pulley and said driven pulley, and said suspension arm including a first end zone coaxially mounted with said drive pulley on said output drive shaft and pivotally moveable about a rotational axis of said output drive shaft, and said suspension arm further including an opposite second end zone with a wheel axle fixed thereto and extending therefrom for rotatably supporting said wheel and said driven pulley; and
a shock absorbing member connecting between said second end zone of said suspension arm and the frame structure of the personal wheeled vehicle for allowing smooth upward movement of said wheel and said driven pulley in response to external forces while absorbing said forces and for urging said wheel downwardly to a normal position.

14. The belt and pulley drive system according to claim 13 wherein said positive engagement self-centering interface comprises a plurality of cogs in a mutually arranged cog pattern on said belt engagement faces of said drive pulley and said driven pulley and on said inner face of said endless belt wherein said belt cogs intermesh with said pulley cogs.

15. The belt and pulley drive system according to claim 14 wherein said cog pattern is a plurality of parallel cogs oriented at an oblique angle with respect to a longitudinal centerline of said endless belt.

16. The belt and pulley drive system according to claim 15 wherein said cog pattern comprises a first group of cogs oriented at a first oblique angle and a second group of cogs oriented at a second oblique angle.

17. The belt and pulley drive system according to claim 16 wherein said longitudinal centerline divides said endless belt into a first side and into a second side and further wherein said first group of cogs are affixed to said first side and said second group of cogs are affixed to said second side.

18. The belt and pulley drive system according to claim 17 wherein said cog pattern is a herringbone pattern.

19. The belt and pulley drive system according to claim 18 wherein said first cog group and said second cog group on said drive pulley and on said driven pulley are laterally separated one from the other such that inner ends of said cogs in combination with said belt engagement faces define a circumferential channel about a periphery of said drive pulley and said driven pulley.

20. A belt and pulley drive system for a personal wheeled vehicle having a frame structure, said belt and pulley drive system comprising:
a rotatable wheel on the vehicle for propelling the vehicle over terrain, and said wheel including a tire for engaging the terrain;
a rotating power source including an electric motor and a reduction gearbox having an output drive shaft;
a drive pulley for fixed attachment to said output drive shaft of said gearbox of said rotating power source, said drive pulley having a belt engagement face;
a driven pulley for fixed attachment to said wheel of the vehicle, said driven pulley having a belt engagement face;
an endless belt having an inner face and extending between said drive pulley and said driven pulley;
a belt tensioner including an adjustable pulley bearing on an outer surface of said endless belt; and wherein said drive pulley and said driven pulley in combination with said endless belt have a positive engagement self-centering interface comprising a plurality of cogs arranged in a herringbone pattern centered about a longitudinal centerline of said endless belt;
a suspension arm for allowing upward and downward movement of said wheel and said driven pulley relative to said drive pulley and said rotating power source while maintaining said endless belt in positive intermeshing engagement with said drive pulley and said driven pulley, and said suspension arm including a first end zone coaxially mounted with said drive pulley on said output drive shaft and pivotally moveable about a rotational axis of said output drive shaft, and said suspension arm further including an opposite second end zone with a wheel axle fixed thereto and extending therefrom for rotatably supporting said wheel and said driven pulley; and
a shock absorbing member connecting between said second end zone of said suspension arm and the frame structure of the personal wheeled vehicle for allowing upward movement of said wheel and said driven pulley in response to external forces while absorbing said external forces and for urging said wheel downwardly to a normal position.
